(19) United States
(12) Patent Application Publication
(10) Pub. No.: US 2005/0164904 A1
(43) Pub. Date: Jul. 28, 2005

(54) Air conditioning system flush solvent

(76) Inventor: Richard L. Miller, Cleburne, TX (US)

Correspondence Address: KONNEKER & SMITH P. C., 660 NORTH CENTRAL EXPRESSWAY, SUITE 230, PLANO, TX, 75074, US

(21) Appl. No.: 10/765,689

(22) Filed: Jan. 27, 2004

(51) Int. Cl. C11D 1/00

(52) U.S. Cl. 510/506

(57) ABSTRACT

An air conditioning system flush solvent. In a described embodiment, an air conditioning system flush solvent includes, by weight: n-propyl bromide approximately 99.7%; methyl nonafluoroisobutyl ether approximately 0.1%; methyl nona fluorobuty ether approximately 0.1%; and methanol approximately 0.1%. The flush solvent is an effective cleaner, evaporates quickly, leaves no residue, is nonflammable and is relatively low in cost.

### BACKGROUND

The present invention relates generally to cleaners and solvents and, in an embodiment described herein, more particularly provides an air conditioning system flush solvent.

In the past, an air conditioning system flush solvent known to those skilled in the art as HCFC-141b was used. However, the Clean Air Act prohibited use of HCFC-141b beyond the year 2002. Thus, the industry has been in need of a replacement for HCFC-141b, but no satisfactory replacements have yet been available.

An air conditioning system flush solvent to replace HCFC-141b should not only comply with the Clean Air Act, but should also clean well, evaporate quickly and leave no residue. In addition, the flush solvent should be nonflammable, because work areas may be enclosed, and the accumulation of flammable vapors is undesirable for obvious reasons. Furthermore, the flush solvent should be relatively low in cost.

From the foregoing, it can be seen that it would be quite desirable to provide an air conditioning system flush solvent which may be used to replace HCFC-141b.

### SUMMARY

In carrying out the principles of the present invention, in accordance with an embodiment thereof, an air conditioning system flush solvent is provided which cleans well, evaporates quickly, leaves no residue, is nonflammable and is relatively low in cost.

In one aspect of the invention, an air conditioning system flush solvent is provided which includes, by weight:
n-propyl bromide approximately 70.0-99.7%;
methyl nonafluoroisobutyl ether approximately 0.1-10.0%;
methyl nona fluorobuty ether approximately 0.1-10.0%; and
methanol approximately 0.1-10.0%.

In another aspect of the invention, an air conditioning system flush solvent is provided which includes, by weight:
n-propyl bromide approximately 99.7%;
methyl nonafluoroisobutyl ether approximately 0.1%;
methyl nona fluorobuty ether approximately 0.1%; and
methanol approximately 0.1%.

These and other features, advantages, benefits and objects of the present invention will become apparent to one of ordinary skill in the art upon careful consideration of the detailed description of representative embodiments of the invention hereinbelow.

### DETAILED DESCRIPTION

The new air conditioning system flush solvent of the present invention is described by the following formula, by weight:

| | |
|---|---|
| n-propyl bromide | 70.0-99.7% |
| methyl nonafluoroisobutyl ether | 0.1-10.0% |
| methyl nona fluorobuty ether | 0.1-10.0% |
| methanol | 0.1-10.0% |

The inventor's research indicates that formulas containing fluorine and bromine work best in air conditioning system flush applications. These are fast evaporating and nonflammable. Another of the halogens, chlorine, enhances cleaning ability, but may have negative environmental effects, and so it is not used in the new flush solvent.

The fluorinated compounds in the above formula (methyl nonafluoroisobutyl ether and methyl nona fluorobuty ether) should be very effective in cleaning fluorinated compounds from an air conditioning system. These combined compounds are commercially available from 3M as HFE-7100. Since the new air conditioning refrigerant, HFC-134a, is a fluorinated compound, the formula should be effective in flushing this compound from an air conditioning system.

The methanol in the above formula should be very effective in cleaning polar soils from an air conditioning system.

The formula contains a substantial proportion of n-propyl bromide, which should be effective in cleaning, as well as having the qualities of evaporating quickly and being nonflammable. The cost of the flush solvent should be relatively low, since the cost of n-propyl bromide is relatively low.

An example of the air conditioning system flush solvent has been prepared and tested. This example was prepared according to the following formula, by weight:

| | |
|---|---|
| n-propyl bromide | 99.7% |
| methyl nonafluoroisobutyl ether | 0.1% |
| methyl nona fluorobuty ether | 0.1% |
| methanol | 0.1% |

In cleaning tests, it was found that a flush solvent prepared according to the above example formula cleaned better than HCFC-141b. To evaluate the cleaning strength of the flush solvent, its Kauri Butanol value was determined in the cleaning tests. While HCFC-141b has a Kauri Butanol cleaning value of 51, the flush solvent example has a more desirable Kauri Butanol cleaning value of 90.

The above flush solvent example was also tested to determine its compatibility with various materials, including materials and components often found in air conditioning systems. The following materials were individually submerged in the flush solvent for one week: HNBR elastomer, neoprene elastomer, non-asbestos fiber gasket, Goodyear® barrier hose, aluminum adapter, steel adapter, Teflon® seal, copper gasket and Ford® springlock garter spring.

None of the metal or fiber materials were affected by the flush solvent. The HNBR and neoprene elastomers swelled to approximately 2-3 times their original size and became softer. However, after removal from the flush solvent the elastomers returned to their original size and hardness within 36 hours. This is acceptable in the air conditioning industry.

Thus, the flush solvent according to the present invention is an effective cleaner for air conditioning systems, is quick evaporating, nonflammable, leaves no residue and is relatively low in cost.

Of course, a person skilled in the art would, upon a careful consideration of the above description of representative embodiments of the invention, readily appreciate that many modifications, additions, substitutions, deletions, and other changes may be made to these specific embodiments, and such changes are contemplated by the principles of the present invention. Accordingly, the foregoing detailed description is to be clearly understood as being given by way of illustration and example only, the spirit and scope of the present invention being limited solely by the appended claims and their equivalents.

1. An air conditioning system flush solvent, comprising by weight:
n-propyl bromide approximately 70.0-99.7%;
methyl nonafluoroisobutyl ether approximately 0.1-10.0%; and
methyl nona fluorobuty ether approximately 0.1-10.0%.

2. The flush solvent according to claim 1, further comprising by weight:
methanol approximately 0.1-10.0%.

3. An air conditioning system flush solvent, comprising by weight:
n-propyl bromide approximately 70.0-99.7%; and
methanol approximately 0.1-10.0%.

4. An air conditioning system flush solvent, comprising by weight:
n-propyl bromide approximately 99.7%;
methyl nonafluoroisobutyl ether approximately 0.1%;
methyl nona fluorobuty ether approximately 0.1%; and
methanol approximately 0.1%.
